(19) United States
(12) Patent Application Publication
(10) Pub. No.: US 2011/0001996 A1
(43) Pub. Date: Jan. 6, 2011

(54) IMAGE FORMING APPARATUS AND IMAGE FORMING METHOD

(75) Inventor: Yuichi Yokoyama, Kanagawa-ken (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/823,355

(22) Filed: Jun. 25, 2010

Related U.S. Application Data
(60) Provisional application No. 61/222,536, filed on Jul. 2, 2009.

(51) Int. Cl. G06K 15/00

(52) U.S. Cl. 358/1.12

(57) ABSTRACT

According to one embodiment, an image forming apparatus includes a setting section configured to set setting information for forming an image on a recording medium, feeding cassette configured to contain the recording medium, a printer configured to form the image on the recording medium in the feeding cassette, a media sensor configured to detect characteristic information of the recording medium, an image forming condition determination section configured to determine a first image forming condition to regulate an image forming operation of the printer based on the characteristic information of the first recording medium in a first print job, a control section configured to control the image forming operation for a second or later recording medium in the first print job in accordance with the first image forming condition, and a storage section configured to classify and store the characteristic information detected by the media sensor.

### CROSS-REFERENCE TO RELATED APPLICATION

This application is based upon and claims the benefit of U.S. Provisional Application No. 61/222,536, filed on Jul. 2, 2009; the entire contents of which are incorporated herein by reference.

### FIELD

Embodiments described herein relate generally to an image forming apparatus and an image forming method.

### BACKGROUND

Hitherto, an image forming apparatus such as a multi function peripheral (MFP) includes plural media sensors to detect characteristics of a sheet. Based on the detection results of the media sensors, the image forming apparatus selects operation conditions, such as conveyance speed, fixing temperature and fixing nip, optimum for the sheet. The image forming apparatus controls an image forming operation based on the selected operation conditions.

Since the conveyance speed can not be changed during image formation, the image forming operation is started after the sheet characteristics are detected. Besides, the fixing temperature is controlled to be the lowest temperature during the standby in the image forming operation, and after the sheet characteristics are detected, the fixing temperature is raised to a specified temperature corresponding to the detection result. As stated above, at the time of start of a job, the operation to adjust the image forming conditions is performed correspondingly to the detection result.

### BRIEF DESCRIPTION OF THE DRAWINGS

FIG. 1 is an exemplary perspective view showing an outer appearance structure of a multi function peripheral according to an embodiment.

FIG. 2 is an exemplary schematic view showing a structure in the multi function peripheral according to an embodiment.

FIG. 3 is an exemplary block diagram showing a structure of a control system of the multi function peripheral according to an embodiment.

FIG. 4 is an exemplary view showing a structural example of a media sensor according to an embodiment.

FIG. 5 is an exemplary view showing a control method of an image forming operation according to an embodiment.

FIG. 6 is an exemplary view showing content of a job according to an embodiment.

FIG. 7 is an exemplary view showing a method for obtaining an image forming condition according to an embodiment.

FIG. 8 is an exemplary view showing content of a detection history data file according to an embodiment.

### DETAILED DESCRIPTION

In general, according to one embodiment, an image forming apparatus includes a setting section configured to set setting information for forming an image on a recording medium, feeding cassette configured to contain the recording medium, a printer configured to form the image on the recording medium in the feeding cassette, a media sensor configured to detect characteristic information of the recording medium, an image forming condition determination section configured to determine a first image forming condition to regulate an image forming operation of the printer based on the characteristic information of the first recording medium in a first print job, a control section configured to control the image forming operation for a second or later recording medium in the first print job in accordance with the first image forming condition; and a storage section configured to classify and store the characteristic information detected by the media sensor.

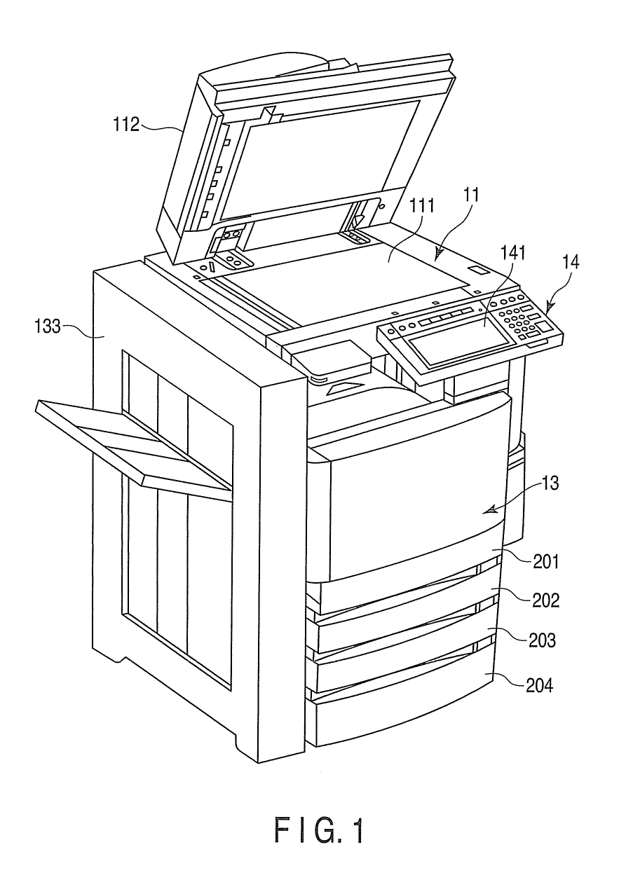

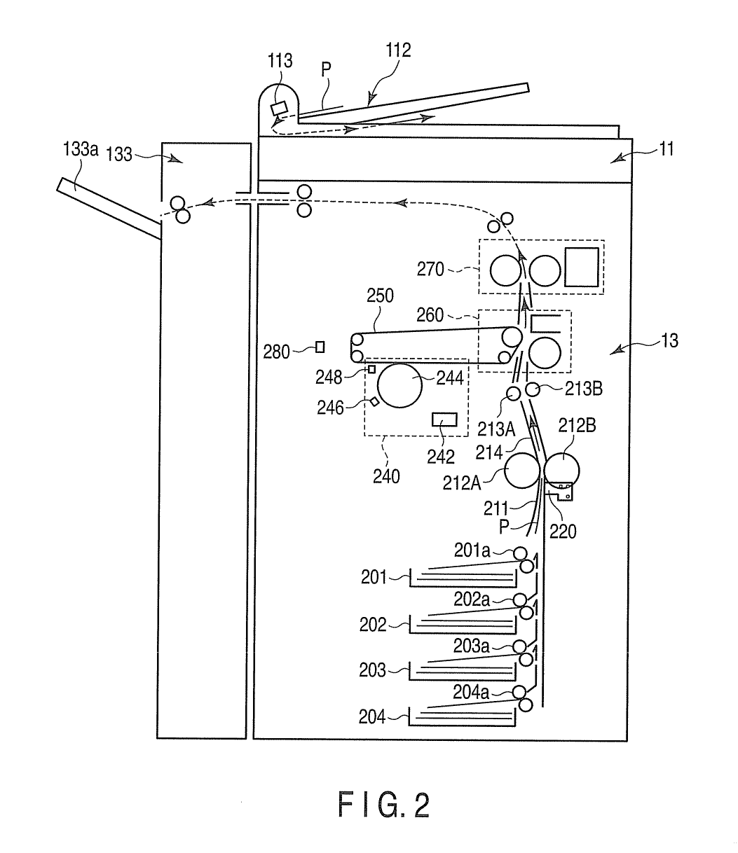

FIG. 1 is an exemplary perspective view showing an outer appearance structure of a multi function peripheral according to an embodiment. FIG. 2 is an exemplary schematic view showing a structure in the multi function peripheral according to an embodiment.

As shown in FIG. 1, a main body of the multi function peripheral 1 includes units such as a scanner 11, a printer 13 and a control panel 14.

The scanner 11 is provided at an upper part of the main body of the multi function peripheral 1. The scanner 11 is an apparatus for optically reading an image of a document. The scanner 11 is composed of a not-shown CCD line sensor or the like. The CCD line sensor reads an image of one line of the document in a main scanning direction. The scanner 11 reads the image of the entire document by causing the CCD line sensor to scan the document in a sub-scanning direction. For example, the scanner 11 reads the image of the entire document by causing the CCD line sensor to scan the document placed on a document table 111 in the sub-scanning direction.

Besides, in the structural example shown in FIG. 1 and FIG. 2, the scanner 11 includes an ADF (Auto Document Feeder) 112. The ADF 112 is disposed at an upper part of the main body of the multi function peripheral 1. The ADF 112 feeds sheet-like documents one by one. The scanner 11 reads the image of the document fed by the ADF 112. The ADF 112 is disposed so that the whole is opened and closed at the upper part of the multi function peripheral 1. In the closed state, the ADF 112 functions also as a cover for the document placed on the document table 111. The ADF 112 is provided with a media sensor 113. The media sensor 113 is a sensor to detect characteristic information indicating the characteristic of a fed document. For example, the media sensor 113 detects information indicating the thickness of the document, the degree of gloss or a material.

The control panel 14 is disposed at the front on the upper surface of the main body of the multi function peripheral 1. The control panel 14 is for displaying a guidance for a user and for receiving an instruction input from the user. For example, the user instructs a copy condition or copy start using the control panel 14.

The control panel 14 includes various operation keys and various indicators. For example, the control panel 14 is provided with a touch panel display 141 as a display device having a built-in touch panel. When various information is displayed or information is inputted, the user confirms the information displayed on the touch panel display 141 and touches an icon indicating a desired instruction content from icons displayed on the touch panel display 141.

The printer 13 includes a paper feed mechanism, a print mechanism and a finishing mechanism. The paper feed mechanism contains a sheet as an image formation target medium. The paper feed mechanism supplies contained sheets to the print mechanism one by one. The print mechanism forms an image on the sheet supplied by the paper feed mechanism. For example, as the print mechanism, various print systems such as an electrophotographic system, an ink-jet system or a thermal transfer system can be applied. Here, as the print mechanism, the electrophotographic system is adopted. The finishing mechanism processes the sheet on which the image is printed by the print mechanism. For example, the finishing mechanism staples or hole punches the sheet subjected to the print processing. In the example shown in FIG. 1 and FIG. 2, a finisher 133 is disposed as the finishing mechanism.

As shown in FIG. 1 and FIG. 2, the printer 13 includes paper feeding cassettes 201, 202, 203 and 204. The paper feeding cassettes 201, 202, 203 and 204 contain sheets subjected to the print processing by the print mechanism. For example, the respective paper feeding cassettes 201, 202, 203 and 204 can be attached to and detached from the lower part of the main body of the multi function peripheral 1. The respective paper feeding cassettes contain various sheets set by the user. In general, each of the paper feeding cassettes contains the same kind of sheets. In this case, a paper feeding cassette is selected to select a kind of sheets.

The respective paper feeding cassettes 201, 202, 203 and 204 are provided with paper feed rollers 201a, 202a, 203a and 204a. The respective paper feed rollers 201a, 202a, 203a and 204a take out sheets contained in the respective paper feeding cassettes 201, 202, 203 and 204 one by one. The sheets taken out by the paper feed rollers 201a, 202a, 203a and 204a are conveyed along conveying paths 211 and 214 by a conveying roller 212 (212A, 212B) and the like. The conveying paths 211 and 214 convey the sheet to a registration roller 213 (213A, 213B).

The registration roller 213 (213A, 213B) is a pair of rollers provided before the print mechanism. The registration roller 213 conveys the sheet conveyed through the conveying paths 211 and 214 to a development transfer section as the print mechanism at a desired timing.

A media sensor 220 is provided on the conveying path 211, 214. The media sensor 220 is provided on the conveying path 211, 214 between each of the paper feed rollers 201a, 202a, 203a and 204a and the registration roller 213 (213A, 213B). The media sensor 220 is a sensor for detecting characteristic information indicating characteristics of the sheet to be conveyed. For example, the media sensor 220 detects the information indicating the thickness of the sheet, the degree of glossiness, or a material. The media sensor 220 may have the same structure as the media sensor 113 provided in the ADF 112.

The print mechanism includes an image forming section 240, an intermediate transfer body 250, a development transfer section 260, a fixing section 270 and a temperature and humidity sensor 280.

The image forming section 240 includes an exposure device 242 and a photoconductive drum 244. Further, the image forming section 240 includes a potential sensor 246 and a density sensor 248. The potential sensor 246 is a sensor to detect the surface potential of the photoconductive drum 244. The density sensor 248 is a sensor to detect the density of a toner image formed on the photoconductive drum 244 or the intermediate transfer body 250. The surface of the photoconductive drum 244 is charged by a not-shown charging charger. The exposure device 242 forms an electrostatic latent image on the photoconductive drum 244 the surface of which is charged. When toner is supplied to the surface of the photoconductive drum 244, the electrostatic latent image on the photoconductive drum 244 becomes a toner image. The photoconductive drum 244 transfers the toner image formed on the surface to the intermediate transfer body 250.

The intermediate transfer body 250 supplies the toner image transferred from the photoconductive drum 244 to the development transfer section 260. The development transfer section 260 transfers the toner image supplied by the intermediate transfer body 250 to a sheet. That is, the registration roller 213 supplies the sheet to the development transfer section 260 in synchronization with the position of the toner image formed on the intermediate transfer body 250. The development transfer section 260 supplies the sheet on which the toner image is transferred to the fixing section 270.

The fixing section 270 includes a heater, a heat roller and a press roller. The fixing section 270 fixes the toner image to the sheet by the heat roller heated by the heater and the press roller. That is, the fixing section 270 heats the sheet on which the toner image is transferred by the development transfer section 260 in the pressurized state. The sheet subjected to the fixing processing by the fixing section 270 is conveyed to the finisher 133.

The finisher 133 processes the sheet P on which the image is formed by the print mechanism. The finisher 133 includes a storage tray for storing the sheet on which the image is formed by the print mechanism. Further, the finisher 133 may have a function of stapling or hole punching the sheet P stored on the storage tray.

The temperature and humidity sensor 280 is a sensor to detect the state in the printer 13. The temperature and humidity sensor 280 detects the temperature and humidity in the printer 13. The temperature and humidity sensor 280 is disposed at a place which is hardly influenced by a local temperature rise caused by the heater in the fixing section 270, various motors or the like.

The structure of a control system in the multi function peripheral 1 constructed as described above will be described.

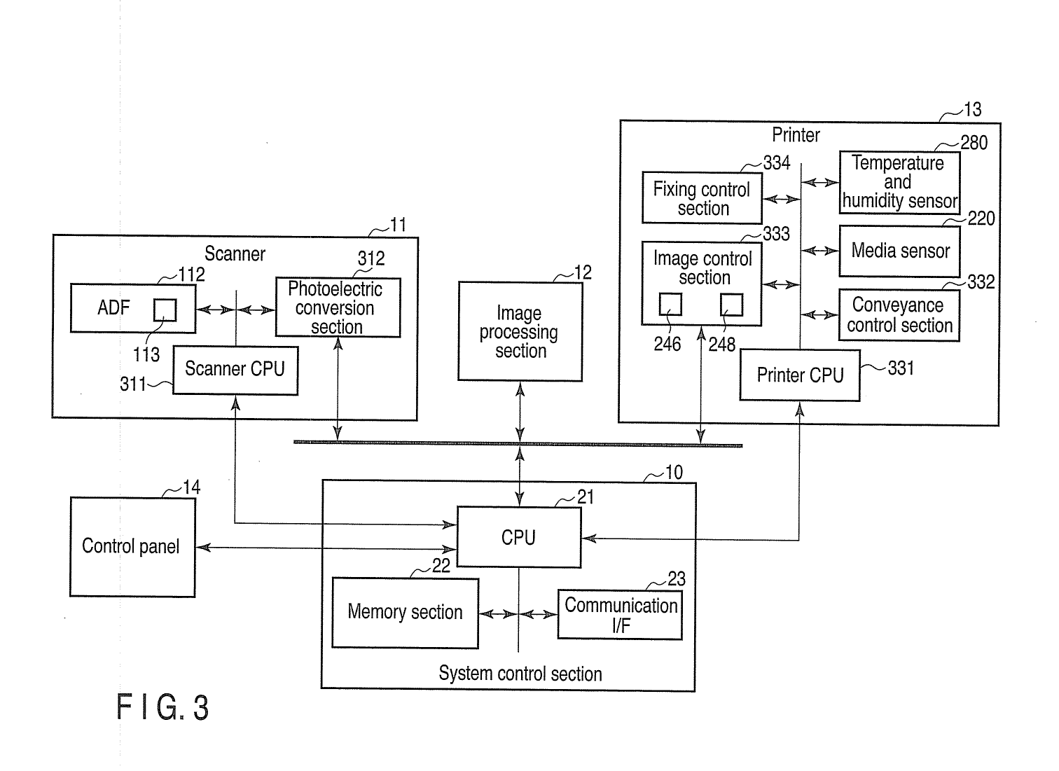

FIG. 3 is an exemplary block diagram showing a structure of a control system of the multi function peripheral according to an embodiment.

The multi function peripheral 1 includes a system control section 10, the scanner 11, an image processing section 12, the printer 13 and the control panel 14.

The system control section 10 includes a CPU 21, a memory section 22 and a communication interface (I/F) 23.

The CPU 21 is connected to the scanner 11, the image processing section 12, the printer 13, the control panel 14 and the like through a not-shown interface. That is, the CPU 21 outputs operation instructions to the respective sections or acquires various information from the respective sections through bidirectional communication with the scanner 11, the image processing section 12, the printer 13 and the control panel 14. For example, the CPU 21 outputs setting information relating to the print processing to the printer 13, and acquires information indicating a print processing result from the printer 13. In this case, the information indicating the print processing result includes information detected by the respective sensors such as the media sensor 220, the potential sensor 246, the density sensor 248 or the temperature and humidity sensor 280.

The memory section 22 includes setting information of the print processing (information indicating the sheet size, color mode, both side mode, the presence or absence of electric sort, etc.), and information detected by the respective sensors such as the media sensor 220, the temperature and humidity sensor and the density sensor, at the time of the print processing.

The CPU 21 controls the image system operation based on the information relating to the characteristics of the sheet detected by the media sensor 220. The details will be described later.

The scanner 11 includes a scanner CPU 311, a photoelectric conversion section 312, the ADF 112 and the media sensor 113.

The scanner CPU 311 controls the scanner 11. The scanner CPU 311 executes a control program stored in a not-shown memory and realizes the function to control the respective sections in the scanner 11. As stated above, the ADF 112 is an apparatus to convey documents one by one. The ADF 12 conveys the document so that the surface of the document passes through a specified main scanning position in a sub-scanning direction. The media sensor 113 detects the characteristic information of the document fed by the ADF 112. The information detected by the media sensor 113 is supplied to the scanner CPU 311.

The photoelectric conversion section 312 converts information obtained by optically scanning the surface of the document into image data. The photoelectric conversion section 312 includes an exposure device and a line sensor. The exposure device exposes the surface of the document. The line sensor is such that photoelectric conversion elements for one line, which convert light into electric signals, are arranged in the main scanning direction. That is, the line sensor reads the image information for one line in the main scanning direction. Besides, the structure to read the image of the document on the document table 111 includes a drive section to move a carriage mounting the exposure device and the line sensor in the sub-scanning direction.

The printer 13 includes, as the structure of the control system, a printer CPU 331, a conveyance control section 332, an image control section 333, a fixing control section 334, the media sensor 220, the potential sensor 246, the density sensor 248 and the temperature and humidity sensor 280.

The printer CPU 331 controls the printer 13. The printer CPU 331 also executes a control program stored in a not-shown memory and realizes the function to control the respective sections in the printer 13. The conveyance control section 332 controls the conveyance of a sheet in the printer 13.

The image control section 333 controls a process to form an image in the printer 13. The image control section 333 controls the image forming section 240 including the exposure device 242 and the photoconductive drum 244. The image control section 333 supplies the detection results of the potential sensor 246 and the density sensor 248 to the printer CPU 331 for each print process on each sheet. The fixing control section 334 controls the fixing section 270. For example, the fixing control section 334 controls the fixing temperature in the fixing section 270.

Next, a structural example of the media sensor 220 will be described.

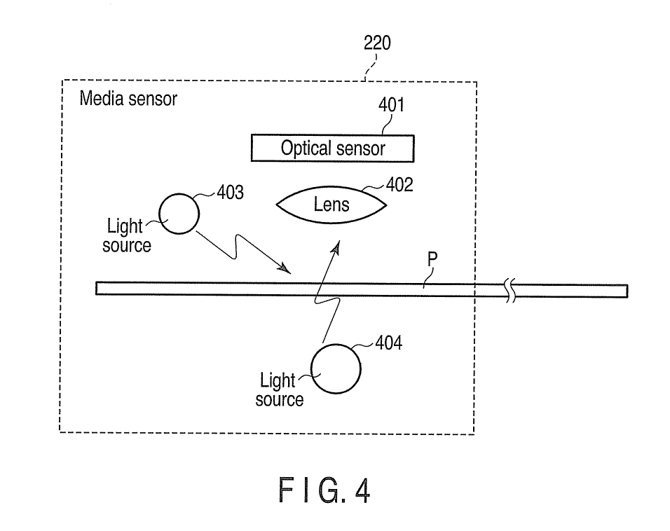

FIG. 4 is an exemplary view showing a structural example of a media sensor according to an embodiment.

In the example shown in FIG. 4, the media sensor 220 includes an optical sensor 401, a lens 402, a reflecting light source 403 and a transmitting light source 404. The media sensor 220 is disposed on the sheet conveying path 211, 214 between the output side position of each of the paper feeding cassettes and the registration roller 213. In the media sensor 220, the reflecting light source 403 and the transmitting light source 404 properly irradiate detecting light to the sheet P.

For example, when the surface state of the sheet P is detected, the reflecting light source 403 irradiates light to the surface of the sheet. The light emitted from the reflecting light source 403 is diffused and reflected according to the surface state of the sheet P. The lens 402 condenses the light diffused and reflected on the surface of the sheet P. The optical sensor 401 converts the reflected light, which is condensed by the lens 402, from the surface of the sheet P into an electric signal. The electric signal indicates the light amount of the reflected light changed according to the surface state of the sheet P.

As the light reflectance on the surface of the sheet P becomes high, the optical sensor 401 outputs a larger electric signal. When the kind of the sheet can be judged by the light reflectance on the surface of the sheet P, the signal outputted from the optical sensor 401 is information indicating the kind of the sheet. Here, with respect to the kind of the sheet, it is assumed that the sheet is standard paper, coat paper or OHP sheet. The light reflectance on the surface is in order of standard paper <coat paper <OHP sheet. Accordingly, threshold values for distinguishing among the standard paper, the coat paper and the OHP sheet can be set for the electric signal outputted from the optical sensor 401. By comparing the threshold values with the value of the electric signal outputted from the optical sensor 401, the media sensor 220 can detect that the sheet P is the standard paper, the coat paper or the OHP sensor.

When the light transmittance of the sheet P is detected (for example, the thickness of the sheet P is detected), the transmitting light source 404 irradiates light to the sheet P. The light emitted from the transmitting light source 404 is transmitted according to the thickness of the sheet P or the like. That is, the light emitted from the transmitting light source 404 becomes transmitted light having a light amount corresponding to the thickness of the sheet P or the like and is transmitted through the sheet P. The lens 402 condenses the light transmitted through the sheet P. The optical sensor 401 converts the transmitted light of the sheet P condensed by the lens 402 into an electric signal. The electric signal indicates the light amount of the transmitted light which is changed according to the thickness of the sheet P or the like.

As the thickness of the sheet P becomes thin, the light transmittance of the sheet P becomes high. As the light transmittance of the sheet P becomes high, the optical sensor 401 outputs a larger electric signal. When the thickness of the sheet can be judged by the light transmittance of the sheet P, the signal outputted from the optical sensor 401 is information indicating the kind of the sheet. Here, with respect to the thickness of the sheet, it is assumed that the sheet is thin paper, standard paper or thick paper. In this case, the light transmittance of the sheet is in order of thin paper >standard paper >thick paper. Accordingly, threshold values for distinguishing among the thin paper, the standard paper and the thick paper can be set for the electric signal outputted from the optical sensor 401. By comparing the threshold values with the value of the electric signal outputted from the optical sensor 401, the media sensor 220 can detect that the sheet P is the thin paper, the standard paper or the thick paper.

The media sensor 220 is not limited to the above structure. For example, by using a fact that an interval between both rolls to nip and convey a sheet is changed by the thickness of the sheet, the thickness of the sheet may be measured by measuring a variation of the roller from a reference position in the state of nipping the sheet. Further, the media sensor 220 may be constructed by combining plural sensors to detect not only the thickness of the sheet but also a surface quality indicating sheet smoothness or roughness, an electric resistance and the like.

Next, a method of controlling an image forming operation based on the detection result of the media sensor 220 will be described. In this embodiment, the media sensor 220 detects the characteristic information relating to the sheet thickness, and the surface quality indicating the sheet smoothness or roughness. The CPU 21 controls the image forming operation based on the detected characteristic information.

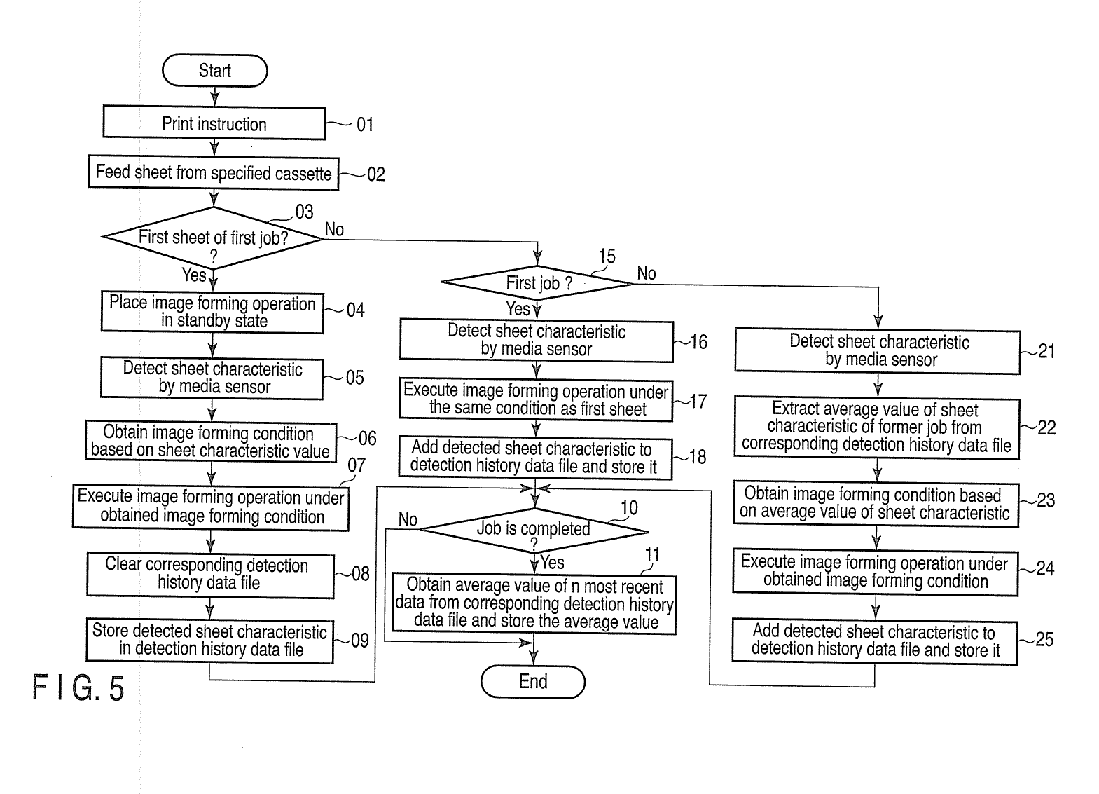

FIG. 5 is an exemplary view showing a control method of an image forming operation according to an embodiment.

At Act 01, when the user inputs the setting on the print process (information indicating the sheet size, color mode, both side mode, the presence or absence of electric sort, etc.) through the control panel 14 and instructs a print start, at Act 02, the CPU 21 instructs the printer CPU 331 to convey sheets from a specified one of the paper feeding cassettes 201, 202, 203 and 204.

At Act 03, the CPU 21 checks whether the print process at this time is the printing of the first sheet in the first job.

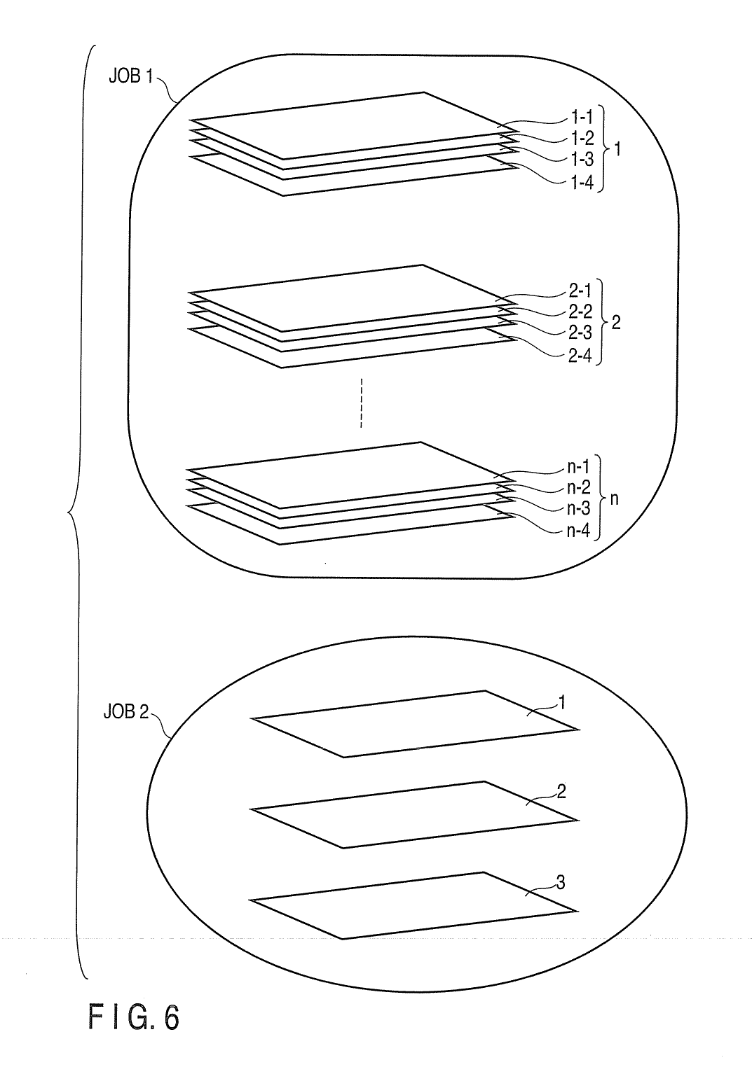

FIG. 6 is an exemplary view showing content of a job according to an embodiment. One job is one print operation instructed by the user. The content of a job 1 is shown at the upper part of FIG. 6. In the job 1, one copy contains four documents, and n copies are printed. A printed sheet is represented by a combination of a copy (1 to n) and a document page (1 to 4). In a job 2, three documents are printed one by one. The “first sheet in a job” is the sheet represented by (1-1) in the job 1, and the sheet represented by (1) in the job 2. That is, the “first sheet in a job” is the sheet which is first printed after the job is started.

Here, whether a job is the first is determined for each of the paper feeding cassettes 201, 202, 203 and 204. When sheets with a characteristic different from a previous one are set in a paper feeding cassette, a job when the sheet with the characteristic is first used is the first job. However, to detect the characteristic of the sheet in the paper feeding cassette results in increase of the cost of the multi function peripheral 1. For example, when sensors are provided for the respective cassettes, the number of the required sensors are equal to the number of the cassettes. Then, in this embodiment, as described above, one sensor is provided on the conveying path 211, 214.

In this embodiment, when the paper feeding cassette is taken in and out, it is assumed that there is a possibility that sheets having a different characteristic are set, and it is determined that the first print job after detecting that the paper feeding cassette is taken in and out is the “first job”. Besides, it is determined that the job first executed after the power source of the multi function peripheral 1 is turned on from off is the “first job”. This is because there is a case where sheets having a different characteristic are set in the paper feeding cassette in the state where the power source is off.

In the case of Yes at Act 03 of FIG. 5, that is, at the time of printing of the first sheet in the first job, at Act 04, the image forming operation is placed in a standby state. That is, the sheet taken out from the paper feeding cassette is conveyed to a place short of the registration roller 213 (213A, 213B) and is once stopped. The media sensor 220 is provided at the position where the sheet can be detected in this state. At this time, the rotation of the photoconductive drum 244 and the exposure onto the photoconductive drum 244, the surface of which is charged, are also placed in the standby state.

At Act 05, the media sensor 220 detects the sheet characteristic such as sheet thickness and surface quality. At Act 06, a sheet conveyance speed V, a nip width W and a fixing temperature T, as image forming conditions, are obtained based on the detected sheet characteristic. Here, the sheet conveyance speed V is a speed at which the sheet is conveyed at the time of transfer of an image. The nip width W is a nip width of two rollers of a heat roller and a press roller in the fixing section 270. The fixing temperature T is a temperature when the sheet on which a toner image is transferred is heated in a pressurized state. It is necessary that appropriate values corresponding to the sheet characteristic are set as these image forming conditions.

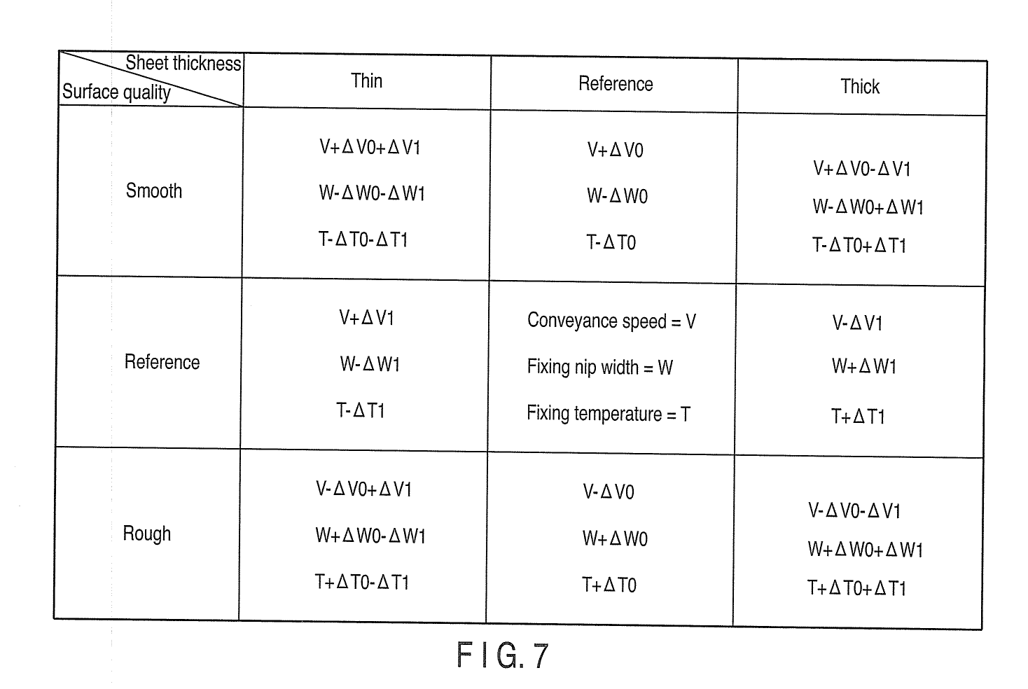

FIG. 7 is an exemplary view showing a method for obtaining an image forming condition according to an embodiment. In FIG. 7, the image forming conditions are changed according to whether the sheet thickness is thicker or thinner than a reference value, and the surface quality is smoother or rougher than a reference value.

When the sheet thickness and the surface quality are the reference values, the conveyance speed is V, the nip width is W, the fixing temperature is T. This state is shown at the center of the matrix of FIG. 7. When the detected sheet thickness is thinner than the reference value, the conveyance speed V is increased by ΔV1, the nip width W is narrowed by ΔW1, and the fixing temperature T is lowered by ΔT1. When the detected sheet thickness is thicker than the reference value, the conveyance speed V is decreased by ΔV1, the nip width W is widened by ΔW1, and the fixing temperature T is raised by ΔT1.

When the detected surface quality is smoother than the reference value, the conveyance speed V is increased by ΔV0, the nip width W is narrowed by ΔW0, and the fixing temperature T is lowered by ΔT0. When the detected surface quality is rougher than the reference value, the conveyance speed V is decreased by ΔV0, the nip width W is widened by ΔW0, and the fixing temperature T is raised by ΔT0.

Also when both the sheet thickness and the surface quality are different from the reference values, the image forming conditions are similarly obtained as shown in FIG. 7. The example shown in FIG. 7 describes how the image forming conditions are changed according to the sheet thickness and the surface quality. In the actual application, various variations can be adopted. The amount of increase or decrease of the image forming condition may be obtained by using a table or a function according to, for example, a deviation amount from the reference value of the sheet thickness and the surface quality.

At Act 07 of FIG. 5, the CPU 21 sets the obtained image forming conditions to the respective sections and executes the image forming operation. At Act 08, the detection history data file stored in the memory section 22 and corresponding to the paper feeding cassette of the sheet used at this time is cleared. At act 09, the sheet characteristic detected by the media sensor 220 is stored in the detection history data file.

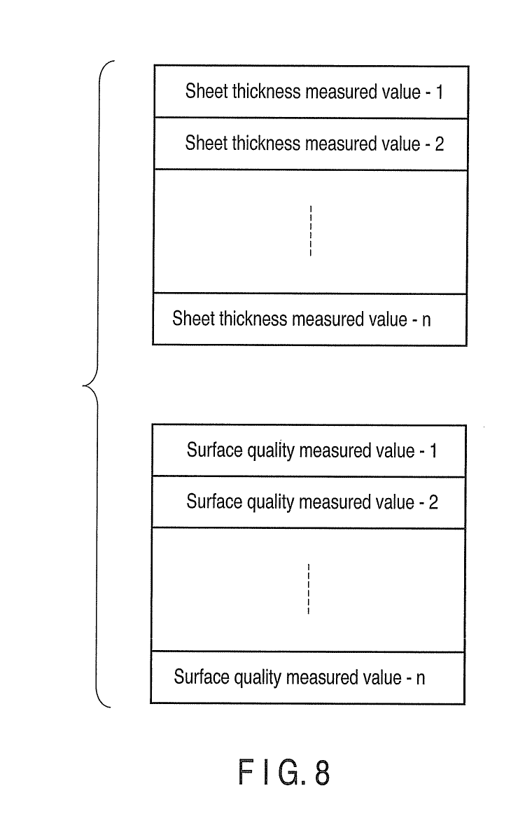

FIG. 8 is an exemplary view showing content of a detection history data file according to an embodiment. At least n detected sheet thicknesses and surface properties from the newest value are stored in the detection history data file.

At Act 10 of FIG. 5, it is checked whether the job is completed. In the case of Yes at Act 10, when the job is completed, the average value of the n most recent data is obtained from the corresponding detection history data file, and the average value is stored in the detection data file. In the case of No at Act 10, when the job is still continued, a next process is on standby.

In the case of No at Act 03 of FIG. 5, that is, when the printing is not for the first sheet in the first job, at Act 15, it is checked whether the printing is for the first job. In the case of Yes At Act 15, that is, when the printing is for the second or later sheet in the first job, at Act 16, the media sensor 220 detects the sheet characteristic such as sheet thickness and surface quality. However, the detected sheet characteristic is not used for this printing.

At Act 17, the image forming operation is executed under the same image forming condition as that of the first sheet. This is because the sheet used for the subsequent printing has the same characteristic as the characteristic detected for the first sheet so that it is not necessary to change the image forming condition. At Act 18, the detected sheet characteristic is added to the detection history data file and is stored.

At Act 10 of FIG. 5, it is checked whether the job is completed. In the case of Yes at Act 10, when the job is completed, an average value of the n most recent data are obtained from the corresponding detection history data file, and the average value is stored in the detection history data file. In the case of No at Act 10, when the job is still continued, a next process is on standby.

In the case of No at Act 15 of FIG. 5, that is, when the printing is not for the first job, at Act 21, the media sensor 220 detects the sheet characteristic such as sheet thickness and surface quality. At Act 22, the average value of the sheet characteristic obtained for the former job is extracted from the detection history data file stored in the memory section 22 and corresponding to the paper feeding cassette of the sheet to be used.

At Act 23, the sheet conveyance speed V, the nip width W and the fixing temperature T, as image forming conditions, are obtained based on the obtained average value of the sheet characteristic. Since the calculation method is the same as that of Act 06, its detailed description is omitted. At Act 24, the CPU 21 executes the image forming operation under the obtained image forming condition. At this time, since the used paper feeding cassette is the same as that in the first job, it is expected that the sheet is the same. That is, since it is conceivable that the image forming conditions are not much changed, it is possible to adjust the image forming condition in a short time. Further, the detection operation by the media sensor 220 becomes unnecessary, and the efficient image forming operation can be realized. At Act 25, the detected sheet characteristic is added to the detection history data file and is stored.

At Act 10 of FIG. 5, it is checked whether the job is completed. In the case of Yes at Act 10, when the job is completed, an average value of the n most recent data is obtained from the corresponding detection history data file, and the average value is stored in the detection history data file. In the case of No at Act 10, when the job is still continued, a next process is on standby.

As a result, the image forming operation of the next job using the cassette is executed based on the n newest sheet characteristics in the former job.

When the image formation of the first sheet in the first job is performed, it is necessary to always perform the detection of the sheet characteristic by the media sensor 220. However, at the time of image formation of a sheet other than that, it is not necessary to perform detection for each sheet, and the sheet characteristic has only to be detected every appropriate number of sheets.

The image forming apparatus of the embodiment described above has remarkable effects as compared with the related art.

At the first job after the paper feeding cassette is taken in and out, after the characteristic of the first sheet is detected, the respective operations, such as the conveyance speed, the fixing temperature and the fixing nip, of the image forming apparatus are controlled based on the result. In the second and subsequent job, the respective operations of the image forming apparatus are controlled based on the previous detection result of the characteristic of the sheet. According to this embodiment, in the first job, since the image forming condition different from a previous one is adjusted in accordance with the detection result of the first sheet, there is a possibility that the print time becomes long. However, in the second or later job, since the detection result close to a previous one can be used, the image forming condition can be adjusted in a short time. Since the first job is the job after the cassette is taken in and out, its frequency is small, and the efficiency of the print time can be made effective in total.

Besides, the detection result used for the control of the second or later job uses the average value of the result detected in the former job. By this, the variation of the detection result is reduced, and the stable control result can be obtained. Incidentally, the change of the sheet characteristic due to time passage can be dealt with by using the n recent sheet characteristics.

Incidentally, the respective functions described in the foregoing embodiment may be constructed using hardware, or may be realized by using software and causing a computer to read programs describing the respective functions. Besides, the respective functions may be constructed by suitably selecting the software and the hardware.

Further, the respective functions can be realized by causing a computer to read a program stored on a not-shown recording medium. Here, the recording form of the recording medium in the embodiment is arbitrary as long as the program can be recorded and can be read by the computer.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An image forming apparatus comprising:
a setting section configured to set setting information for forming an image on a recording medium;
at least one feeding cassette configured to contain the recording medium;
a printer configured to form the image on the recording medium in the feeding cassette selected based on setting content set by the setting section;
a media sensor configured to detect characteristic information of the recording medium on which the printer forms the image;
an image forming condition determination section configured to determine a first image forming condition to regulate an image forming operation of the printer based on the characteristic information of the first recording medium in a first print job after the feeding cassette is taken in and out or a power source of the image forming apparatus is turned on;
a control section configured to control the image forming operation for a second or later recording medium in the first print job in accordance with the first image forming condition; and
a storage section configured to classify, as history information and for each of the feeding cassettes, the characteristic information detected by the media sensor and to store the characteristic information.

2. The apparatus according to claim 1, wherein
the image forming condition determination section determines a second image forming condition to regulate the image forming operation of the printer for a print job subsequent to the first print job based on the characteristic information stored as the history information, and
the control section controls the image forming operation for the print job subsequent to the first print job in accordance with the second image forming condition.

3. The apparatus according to claim 2, wherein the image forming condition determination section determines the second image forming condition based on an average value of a specified number of the recent characteristic information.

4. The apparatus according to claim 3, further comprising a history erasing section to clear the past history information corresponding to the same feeding cassette before the characteristic information of the first recording medium in the first print job is stored.

5. The apparatus according to claim 4, wherein the characteristic information includes information of at least a thickness of the recording medium and a surface roughness.

6. The apparatus according to claim 5, wherein the image forming condition includes at least a sheet conveying speed, a fixing nip width and a fixing temperature.

7. The apparatus according to claim 4, wherein the media sensor detects the characteristic information for each of the recording media.

8. The apparatus according to claim 1, wherein the media sensor detects the characteristic information of the recording medium on a sheet conveying path between an output side of the feeding cassette and a registration roller to convey the recording medium to the printer at a desired timing.

9. The apparatus according to claim 8, wherein the media sensor detects a physical amount relating to at least a thickness of the recording medium and a surface roughness.

10. An image forming method of an image forming apparatus which includes a setting section that sets setting information for forming an image on a recording medium, at least one feeding cassette that contains the recording medium, a printer that forms the image on the recording medium in the feeding cassette selected based on setting content set by the setting section, and a media sensor that detects characteristic information of the recording medium on which the printer forms the image, the image forming method comprising:
determining a first image forming condition to regulate an image forming operation of the printer based on the characteristic information of the first recording medium in a first print job after the feeding cassette is taken in and out or a power source of the image forming apparatus is turned on;
controlling the image forming operation for a second or later recording medium in the first print job in accordance with the first image forming condition; and
classifying, as history information and for each of the feeding cassettes, the characteristic information detected by the media sensor and storing the characteristic information.

11. The method according to claim 10, further comprising:
determining a second image forming condition to regulate the image forming operation of the printer for a print job subsequent to the first print job based on the characteristic information stored as the history information; and
controlling the image forming operation for the print job subsequent to the first print job in accordance with the second image forming condition.

12. The method according to claim 11, wherein the second image forming condition is determined based on an average value of a specified number of the recent characteristic information.

13. The method according to claim 12, further comprising
clearing the past history information corresponding to the same feeding cassette before the characteristic information of the first recording medium in the first print job is stored.

14. The method according to claim 13, wherein the characteristic information includes information of at least a thickness of the recording medium and a surface roughness.

15. The method according to claim 14, wherein the image forming condition includes at least a sheet conveying speed, a fixing nip width and a fixing temperature.

16. The method according to claim 13, wherein the media sensor detects the characteristic information for each of the recording media.

17. The method according to claim 10, wherein the media sensor detects the characteristic information of the recording medium on a sheet conveying path between an output side of the feeding cassette and a registration roller to convey the recording medium to the printer at a desired timing.

18. The method according to claim 17, wherein the media sensor detects a physical amount relating to at least a thickness of the recording medium and a surface roughness.

19. An image forming apparatus comprising:
setting means for setting setting information for forming an image on a recording medium;
at least one feed means for containing the recording medium;
print means for forming the image on the recording medium in the feed means selected based on setting content set by the setting means;
detection means for detecting characteristic information of the recording medium on which the print means forms the image;
image forming condition determination means for determining a first image forming condition to regulate an image forming operation of the print means based on the characteristic information of the first recording medium in a first print job after the feed means is taken in and out or a power source of the image forming apparatus is turned on;
control means for controlling the image forming operation for a second or later recording medium in the first print job in accordance with the first image forming condition; and
storage means for classifying, as history information and for each of the feed means, the characteristic information detected by the detection means and for storing the characteristic information.

20. An image forming apparatus comprising:
at least one feeder configured to feed a recording medium;
a printer configured to form an image on the recording medium in the feeder;
a media sensor configured to detect characteristic information of the recording medium on which the printer forms the image;
a recording media supplying sensor to detect supplying of the recording medium to the at least one feeder,
an image forming condition determination section configured to determine a image forming condition of the printer, the image forming condition determination section awaiting the characteristic information of the recording medium detected by the media sensor only when a first recording media of a first job is supplied from the feeder for which the recording media supplying sensor detects the supplying of the recording medium.
